(19) United States
(12) Patent Application Publication
(10) Pub. No.: US 2025/0217603 A1
(43) Pub. Date: Jul. 3, 2025

(54) LARGE LANGUAGE MODEL AND NEURAL NETWORKS FOR CATEGORICAL CLASSIFICATION OF NATURAL LANGUAGE TEXT

(71) Applicant: The Bank of New York Mellon, New York, NY (US)

(72) Inventors: Badri MANGALAM, New York, NY (US); Steven REILLY, New York, NY (US); Florance WU, New York, NY (US); Jeevan WARNER, New York, NY (US)

(21) Appl. No.: 18/418,969

(22) Filed: Jan. 22, 2024

Related U.S. Application Data
(60) Provisional application No. 63/615,350, filed on Dec. 28, 2023.

(51) Int. Cl. G06F 40/40

(52) U.S. Cl. CPC G06F 40/40

(57) ABSTRACT

The disclosure relates to systems and methods of identifying concepts in content having natural language text using a Large Language Model (LLM), training neural networks in a discovery phase to classify the identified concepts into categories, sub-categories, or other groupings of concepts, and executing the neural networks in an operational phase to classify identified concepts.

### CROSS-REFERENCE TO RELATED APPLICATIONS

This application claims priority to U.S. Provisional Application No. 63/615,350, filed Dec. 28, 2023, the subject matter of which is incorporated herein by reference in its entirety.

### BACKGROUND

Natural language text in content may contain valuable insights in a variety of contexts. For example, transcripts of spoken conversations, electronic communications, movie scripts, song lyrics, news articles, and other content may include words or phrases that express something about the speaker, the content, and/or other topics of interest. Mining this data can be valuable yet prove to be challenging. In part, this is because of the variability in the way people speak or write.

Some systems may be used to generate records relating to the content. For example, Customer Relationship Management (CRM) tools may implement forms for call centers to document various aspects of a call from customers. However, the data input into the forms by call center agents may be incomplete. For example, the call center agent may manually update the CRM tool to identify why the customer was calling. If the customer had more than one intent, some of these may not be entered by the call center agent. Other valuable aspects such as a reason or action taken by the call center agent may be omitted altogether. As such, analysis on this CRM data may be missing important contextual data, including an indication of whether the agent guided the customer or processed the request on behalf of the customer. This prevents discovery of inefficiencies such as where to improve systems for customer experiences, including self-service capabilities.

Machine learning techniques such as neural networks may be used to learn from massive quantities of data, but doing so requires high quality labels of the groupings (such as categories and sub-categories) that may be unavailable. Computationally identifying concepts from content can be difficult because doing so requires a deep understanding of language. Additionally, categorizing concepts into categories, sub-categories, and/or other groupings will require a detailed understanding of the relevant information domain. For example, it may be difficult to categorize a specific intent identified from content according to company-specific categories or sub-categories because the neural networks do not have a linkage between the large amounts of text and the specific categories or sub-categories. Simply put, the neural networks may be unable to categorize large volumes of data in a way that fits categories that are useful for an organization. Generating these labels can be time consuming and inefficient. These and other issues may exist with analyzing and categorizing large volumes of content having natural language text.

### SUMMARY

Various systems and methods may identify one or more concepts from content having natural language text using Large Language Models (LLMs) for training and executing neural networks to categorize each of the concepts. For example, to address the large scale data and missing data of interest that have not been extracted from natural language text, a system may generate and provide prompts to an LLM to identify concepts that represent subject matter of interest from the natural language text. The LLM is a model that is trained on a large corpus of text to understand language semantics, recognize language structure, and understand other aspects of natural language. In the context of a call center, for example, a concept may include the intent of the caller, the reason for the call, and an action taken by the call center agent. The LLM may identify and extract the concepts from the entire transcript, thereby providing complete extraction of the concepts of interest.

The system may train and use neural networks to classify content based on groupings of the concepts identified by the LLM. For example, in the context of a call transcript, the LLM may be prompted to identify the concepts: intent, reason, and action from the call transcript. The neural networks may be trained to identify a category, a sub-category, and/or other groupings of a concept of a given transcript. Each neural network may be specifically trained to do this classification for a specific concept. For example, an intent classifier may be a neural network specifically trained to classify an intent identified from a transcript, a reason classifier may be a neural network specifically trained to classify reason identified from a transcript. An action classifier may be a neural network specifically trained to classify an action identified from a transcript.

To illustrate, the LLM may output a first intent “make a redemption” and a second intent “make a payment” from the same or different transcript. These intents may be respectively grouped into a sub-category called “redemption requests” and “payment requests.” The neural network may be further trained to identify when these sub-categories correspond to a higher-level category called “payment and transactions.” Thus, the first intent may be categorized into the “payment and transactions” category and sub-categorized into the “redemption requests” sub-category. Likewise, the second intent may be categorized into the “payment and transactions” category and sub-categorized into the “payment requests” sub-category. The neural networks may be trained to classify a transcript's identified concept into other groupings as well.

In another example context, the LLM may be prompted to identify the concepts: genre and maturity rating of a movie based on the dialog transcript (such as a closed-captioning or other dialog transcript). In this context, a neural network may be trained to group the genre into categories, sub-categories, or other groupings. Similarly, another neural network may be trained to group the maturity rating into categories, sub-categories, or other groupings. The system may be used in other contexts as well.

To train the neural networks, the system may operate in a discovery phase. During the discovery phase, the system may leverage the LLM to generate labels for supervised or semi-supervised training. To do so, the system may cluster concepts such as intent, reason, and action (or genre and maturity rating in the movie context) by generating text embeddings of words or phrases of each concept and then clustering the text embeddings based on similarity.

To illustrate, the call center context will be described. The system may include a clustering subsystem that generates text embeddings for each concept identified by the LLM and cluster the text embeddings based on their similarity to one another. Thus, even if different words or phrases are used, the words or phrases of the intents as output by the LLM may still be clustered together based on their text embeddings. Each cluster of concepts may represent a grouping of the concept. For example, a cluster of text embeddings derived from the word or phrases of an intent from the LLM may represent a grouping of similar intents. The clustering subsystem may then provide the clusters to the LLM and prompt the LLM to generate a label. Thus, labeling on large scale data may be automated, leveraging the LLM to not only identify concepts but also automatically generate labels that are based on those concepts.

Each of these labels may be considered a sub-category name for a cluster. Thus, each cluster of text embeddings corresponds to a sub-category of the intent. Each of the transcripts involved in the cluster of text embeddings (these would be the transcripts from which the intents are identified) may be labeled with the label for training the neural networks (intent classifier in this example). The system may then cluster the sub-category names together based on their words and phrases in a similar manner, such as by generating text embeddings for each sub-category name. Doing so will result in a grouping of sub-categories into a respective category. The system may prompt the LLM to generate a category name, which will be used to label corresponding transcripts for training the neural networks. Once the sub-category and category labels are generated by the LLM, the system may, in some instances, initiate a review of the labels to ensure they are appropriate. This review may be conducted by domain experts or other users in a human-in-the-loop processing. Alternatively, or additionally, this review may be automated based on rules or empirical observations. Regardless of the manner of review, once the labels are approved, the system may have automatically developed an LLM-mediated training dataset of transcripts that are labeled with category labels, sub-category labels, and/or other group label. In this way, the neural networks may learn text features (such as words, phrases, structures, or other language features) that correspond to the category labels, sub-category labels, and/or other grouping label.

When the neural networks are trained (or retrained as described herein), the system may execute in an operational phase. During the operational phase, the LLM may identify the intent, reason, and action from an input transcript. The neural networks may each execute to classify its respective concept. For example, the intent classifier may classify the transcript according to an intent, an intent category, an intent sub-category. The reason and action classifiers may similarity classify the transcript. The result is an that the input transcript may be classified in a way that intent-category-sub-category, reason-category-sub-category, and action-category-sub-category mappings are determined, enabling rich analysis of the call. This may enable the system to identify areas of improvement, mitigate problems, and/or otherwise obtain other insights. Other contexts may benefit in similar or different ways. For example, in the movie context, the system may enable richer and automated ways to recommend or search for movies.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system for identifying one or more concepts from content having natural language text using large language models (LLMs) for training and executing neural networks to categorize each of the concepts, according to an implementation.

FIG. 2 illustrates a schematic flow of an example discovery phase for training a neural network to categorize concepts such as intents, reasons, and actions identified by the LLM from transcripts, according to an implementation.

FIG. 3 illustrates a schematic flow of an example operational phase of a neural network that categorizes concepts such as intents, reasons, and actions identified by the LLM from a transcript, according to an implementation.

FIG. 4 illustrates a flow diagram of an example method of training one or more neural networks to categorize a concept identified by an LLM from content having natural language text, according to an implementation.

FIG. 5 illustrates a flow diagram of an example method of training an intent classifier to categorize an intent identified by an LLM from a call transcript, according to an implementation.

FIG. 6 illustrates a flow diagram of an example method of identifying an intent, a reason, and an action in a transcript having natural language text using an LLM and classifying each intent, reason, and action based on a plurality of neural networks, according to an implementation.

FIG. 7 illustrates a flow diagram of an example method of identifying an intent, a reason, and/or an action in a transcript having natural language text using an LLM and classifying each intent, reason, and/or action based on one or more neural networks, according to an implementation.

### DETAILED DESCRIPTION

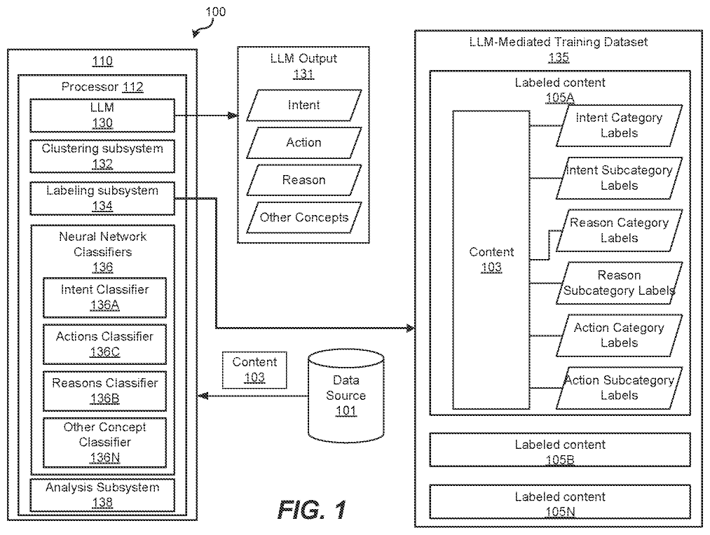

FIG. 1 illustrates an example of a system 100 for identifying concepts from content having natural language text using large language models (LLMs) for training and executing neural networks to categorize each of the concepts, according to an implementation. A concept is subject matter that is expressed by one or more words or phrases in natural language text. The particular types of concepts that are identified by an LLM and the classification of the concepts by the neural networks will vary depending on the particular implementation of the system 100.

For instance, in the context of a transcript of a call made to a call center, examples of concepts identified by the LLM may include an intent of the caller (“intent”), a reason for the call (“reason”), and an action taken by the call center (“action”). The neural networks in this context may be trained to classify an input transcript into classes corresponding to categories and sub-categories of each of the intent, reason, and action. Other contexts may include a transcript or description of multi-media content such as movies, music, and the like. In this example, the concept may include genres, maturity ratings, and other subject matter that may be identified by the LLM from natural language associated with the multi-media content. The neural networks in this context may be trained to classify an input natural language associated with multi-media content into classes corresponding to categories and sub-categories of each of the genre, maturing rating, or other concept.

Examples herein throughout will be described in the context of the call transcript for identifying and categorizing the concepts of intent, reason, and action. However, these examples are provided for illustration. Other types of concepts, including concepts for the multi-media context, may be identified and categorized, as would be appreciated.

As shown in FIG. 1, the system 100 may include one or more data sources 101, a computer system 110, one or more client devices 160 (illustrated as client devices 160A-N), and/or other components. A data source 101 may store and provide content 103 having text that is used by an LLM to identify concepts that are clustered and used to train the neural network classifiers to categorize the concepts. The content 103 may include any content that includes natural language text. Examples of content 103 may include transcripts of communications such as call or speech transcripts in which spoken words are transcribed into text, electronic communications such as e-mail or short message service (SMS) messages, documents, articles, and/or other types of content having natural language text.

The computer system 110 may include one or more processors 112. A processor 112 may include one or more of a digital processor, an analog processor, a digital circuit designed to process information, an analog circuit designed to process information, a state machine, and/or other mechanisms for electronically processing information. Although processor 112 is shown in FIG. 1 as a single entity, this is for illustrative purposes only. In some embodiments, processor 112 may comprise a plurality of processing units. These processing units may be physically located within the same device, or processor 112 may represent processing functionality of a plurality of devices operating in coordination.

As shown in FIG. 1, processor 112 is programmed to execute one or more computer program components. The computer program components may include software programs and/or algorithms coded and/or otherwise embedded in processor 112, for example. The one or more computer program components or features may include an LLM 130, a clustering subsystem 132, a labeling subsystem 134, a neural network 136, and/or other components or functionality.

The neural network 136 may include a plurality of concept-specific classifiers that each classify the concepts identified by the LLM 130. As such, the concept-specific classifiers may include an intent classifier 136A, an actions classifier 136B, a reasons classifier 136C, and/or other concept classifiers 136N. The LLM 130 may execute on-premises and/or be executed via a network-accessed implementation, such as a cloud-based or Application Programming Interface (API) service (not shown in FIG. 1).

The LLM 130 may identify a concept from the words or phrases of the content. Computationally identifying concepts from content can be difficult because doing so requires a deep understanding of language. Furthermore, categorizing concepts into categories and sub-categories will require a detailed understanding of the relevant information domain. A large language model refers to a sophisticated artificial intelligence (AI) system that is trained on large amounts of text data to understand and generate content such as text. Typically, LLM 130 is based on a transformer architecture, which efficiently handles sequential data such as natural language. Transformers use attention mechanisms that weigh different parts of input sequences differently, allowing the model to focus attention on relevant information, such as relevant parts of natural language text. The LLM 130 may be pre-trained on large datasets using unsupervised learning. During this phase, the LLM 130 learns to predict the next word in a sentence or fill in missing words by understanding the contextual relationships within the data. The pre-trained model may capture a broad understanding of language, and this knowledge is then transferred to specific tasks.

The LLM 130 may generate an LLM output 131 that indicates the identified concepts in each transcript. For example, the LLM output may include an indication of one or more intents identified from a transcript, one or more actions identified from the transcript, one or more reasons identified from the transcript, and/or other concepts identified from the transcript. An example of an LLM output 131 is shown below in Table 1. It should be noted that the LLM output 131 may be generated in other formats.

Table 1 shows an example LLM output 131 in JSON format. The LLM output 131 encodes concepts identified from a transcript. In some implementations, multiple LLM outputs 131 may be generated. For example, at least one LLM output 131 may be generated for each transcript that is analyzed by the LLM 130. In other implementations, the LLM output 131 may include the result of processing multiple transcripts in which the intent, reason, and/or action for each transcript is separated by a record separator, such as a JSON record separator.

```
“callSummary” : [
  {
    “Intent” : “Check Account Balance”,
    “Agent Action” : [
      “Guided the Customer”
    ],
    “Reason” : [
      “Driving”
    ]
  },
  {
    “Intent” : “Make a Withdrawal”,
    “Agent Action” : [
      “Performed Action on Behalf of Customer”
    ],
    “Reason” : [
      “Need Money”
    ]
  }
]
```

The LLM output 131 illustrated in Table 1 encodes two sets of caller intent-reason-actions that the LLM 130 identified from the input call transcript.

The clustering subsystem 132 may generate text embeddings associated with each concept and cluster the concepts from different transcripts based on similarity of the text embeddings to one another. A text embedding is a numerical representation such as a vector that represents the meaning of words or phrases. Text embeddings encode semantic information and relationships between words learned from a large corpus of text. To generate the text embeddings, the clustering subsystem 132 may use a system trained on large datasets. Examples of text embedding systems include LaMDA, Universal Sentence Encoder, SentenceTransformers, FastText, GloVe, Contextual Embeddings from Transformers (CoVe), ALBERT, and Longformer, among others. In a particular example, the clustering subsystem 132 may provide text from a concept as input to the text embedding system to generate a corresponding text embedding.

The clustering subsystem 132 may perform clustering in a pairwise manner and/or non-pairwise manner. In pairwise clustering, pairs of text embeddings are compared for similarity to one another. Because a text embedding is a numeric representation such as a vector, the clustering subsystem 132 may measure similarity between text embeddings using one or more distance metrics that quantify the difference between vectors. Examples of distance metrics may include Cosine similarity, Euclidean distance, and Manhattan distance. Cosine similarity measures the angle between two vectors in which case a smaller angle indicates higher similarity. Euclidean distance may measure a straight-line distance between two vectors in which case a smaller distance indicating higher similarity. Manhattan distance may sum the absolute differences between corresponding components of two vectors.

In pairwise clustering, the clustering subsystem 132 may generate a similarity score between two text embeddings based on the distance metric and then cluster corresponding intents (or other concepts) based on their similarity scores. The similarity score may be expressed in various ways so long as the score is used consistently to gauge similarity of text embeddings. For example, the clustering subsystem 132 may scale the distance metric to be within a range of 0.0 to 1.0 in which 1.0 is high similarity and 0.0 is no similarity. Using this scale, the clustering subsystem 132 may identify text embeddings that are similar to one another. To this end, the clustering subsystem 132 may use a threshold cutoff similarity score for clustering. That is, text embeddings and their corresponding concepts may be clustered together when their similarity score is above a threshold similarity score(S), where S is a value between the range of 0.0 and 1.0 in the foregoing example. The threshold similarity score may be predefined and/or configured as appropriate. For example, threshold similarity score may be configured based on the number of clusters desired, the distribution of the actual data, and/or other factors.

Non-pairwise clustering may involve clustering in a more scalable way, which may be advantageous when in a discovery phase for training neural networks 136 using large amounts of content from the data source 101. Examples of such non-pairwise clustering may include hierarchical clustering, spectral clustering, density-based clustering, and deep-learning based clustering.

Hierarchical clustering involves iteratively grouping similar points together, forming a tree-like structure. They can handle both pairwise and non-pairwise comparisons, utilizing various distance metrics and linkage algorithms to build the clusters. Spectral clustering leverages eigenvectors of a similarity matrix constructed from text embeddings. This matrix captures the overall relationships between data points, not just pairwise comparisons. Spectral clustering can effectively identify non-linear clusters and complex relationships within the data. Density-based clustering may include DBSCAN and HDBSCAN focus on identifying dense regions of points in the high-dimensional space. They don't rely solely on pairwise distances and can effectively handle clusters of various shapes and densities. Deep learning-based clustering may include architectures such as autoencoders and variational autoencoders (VAEs) that learn latent representations of the data, which can then be used for clustering. These models capture complex relationships and non-linear structures within the data, going beyond pairwise comparisons.

An example operation of the LLM to identify intent from three transcripts will be described for illustration. The LLM 130 may identify intents in three transcripts: a first intent “check account balance” from a first transcript; a second intent “find out how much money I have in my account” from a second transcript, and a third intent “change my password” from a third transcript. Each of these transcripts may be transcriptions of different calls by the same or different participants. It should be noted that other intents may be identified from one or more of the three transcripts, but these are omitted for clarity. The clustering subsystem 132 may attempt to cluster these intents by generating a first text embedding, a second text embedding, and a third text embedding based on the words in the first intent, the second intent, and the third intent, respectively.

For example, an intent “check my account balance” may be similar to an intent of “find out how much money I have in my account” based on an embedding space that is trained on large datasets and indicates these phrases are similar to one another. More particularly, their respective embeddings (vectors) will be close together in the embedding space. On the other hand, an intent of “I want to change my password” is not similar to “check my account balance” and will therefore have an embedding (vector) that is further from the embedding for “check my account balance.” In this examples, the clustering subsystem 132 may generate two clusters: a first cluster for the first and second intents and a second cluster for the third intent.

The labeling subsystem 134 may generate a label for each of the clusters of concepts generated by the clustering subsystem 132. For example, the labeling subsystem 134 may prompt the LLM 130 to generate a first cluster name for the first cluster and a second cluster name for the second cluster. The resulting output from the LLM 130 may be used as a sub-category name for labeling the respective first and second clusters. For example, since the first cluster included the first and second intents, the first transcript and the second transcript will be labeled with the first cluster name for training purposes. Likewise, the third transcript will be labeled with the second sub-category name for training purposes.

The labeling subsystem 134 may use the clustering subsystem 132 to cluster sub-categories names together in a manner similar to the clustering performed for intents and other concepts. The labeling subsystem 134 may use these clusters to prompt the LLM 130 to generate a category name, again in a manner similar to generating sub-category names. The category name may be applied as a label to the respective transcripts to generate an LLM-mediated training dataset 135. Thus, after labeling by the labeling subsystem 134, the analyzed transcripts will be labeled according to their concept, concept category label, and concept sub-category labels. This process may be repeated for various concepts, such as for intents, reasons, and actions so that the category and sub-category (and/or other sub-groupings) of these concepts may be labeled for training a neural network 136 to identify categories and sub-categories for the concepts.

The neural networks 136 are each a neural network specifically trained to classify content 103 into categories, sub-categories, and/or other groupings of a given input concept. In particular, the neural networks may include an intent classifier 136A, a reasons classifier 136B, an actions classifier 136C, and/or other concept classifiers 136N. More specifically, the neural networks 136 may each be trained based on labeled training data from which each neural network 136. For example, content 103 in the training data may each be labeled with one or more labels. In particular, transcripts in the training data may each be labeled with one or more intent categories, one or more intent sub-categories, one or more reasons categories, one or more reasons sub-categories, one or more actions categories, one or more actions sub-categories, and/or other concept groupings. Thus, each transcript in the training data may be labeled with one or more concept groupings (such as the categories and sub-categories for intents, reasons, and actions) determined for the transcript by the LLM 130, clustering subsystem 132, and the labeling subsystem 134.

### Training the Neural Networks Based on Labeled Text

For illustration, training the neural networks 136 will be described in the context of labeled transcripts, although other types of content 103 may be used. Each of the transcripts may be pre-processed to anonymize or remove personally identifying information such as names and government-issued identification numbers. Preprocessing may also involve converting the transcripts into numerical representations such as vectors for training machine learning models. This preprocessing may be performed using stemming, lemmatization, and/or word embeddings such as Word2Vec, GloVe, and/or other word embedding techniques, including those described herein.

Each of the labels corresponding to the categories and subcategories (such as the intent categories, intent sub-categories, reason categories, reason sub-categories, action categories and action sub-categories) may be assigned to each transcript. The neural network 136 learns to extract features from the text (such as natural language text) of the transcripts. Such features may include words, n-grams, and/or other linguistic or semantic units.

Each neural network 136 is modeled as a plurality of neurons in multiple network layers. The number of network layers used may be configured as needed for the specific implementation. A neuron may be connected to other neurons in the network, and such connections may be weighted. The weighted connections between neurons are important in associating features in the transcript text with the labels corresponding to the concept category, concept sub-category, and/or other grouping. For example, each weight influences the strength of the signal transmitted from a sending neuron to a receiving neuron. Higher weights indicate a stronger influence, meaning the signal from the sending neuron will have a greater impact on the activation of the receiving neuron. Adjusting these weights during training allows the network to learn the relationships between features in the input text and the corresponding labels.

The connections between neurons in the initial one or more layers of the network may be feature detectors that determine the presence or absence of specific features in the transcript text, activating with varying degrees of intensity depending on the weight of the connection and the specific feature that has been detected. The weights (which may also be referred to as parameters) may be initially set to a random value and will be adjusted during the training process. The weights are therefore “learned” during the training process based on the transcripts that have been labeled as described herein. This allows the network to strengthen the connections that contribute to accurate predictions and weaken those that lead to errors. Over time, the network refines its understanding of the relationships between features and categories, leading to improved classification accuracy.

Each neuron in the network also has a bias weight, which adds a constant value to the weighted sum of its inputs before applying the activation function. This allows the neuron to shift its activation level, potentially amplifying or suppressing the overall signal it receives. Adjusting bias weights can compensate for imbalances in the weighted sum and fine-tune the network's response to specific input patterns.

In a forward pass of the neural network 136, text is fed through the network, entering the input layer. Each neuron in the subsequent layers receives weighted sums of activations from the previous layer. These activations are passed through an activation function to introduce non-linearity. Examples of an activation function that may be used include the Sigmoid activation function, a rectified linear unit (ReLU) activation function, and others. Some activation functions, like the ReLU activation function, have additional parameters that control their shape and behavior. These parameters influence the non-linearity introduced by the activation function and can affect the network's ability to learn complex relationships in the data.

As the information flows through the network of neurons, subsequent layers combine and transform extracted features. Connections between neurons in these layers learn to associate certain combinations of features with specific categories. Each connection represents a specific relationship between features, and its weight determines the strength and importance of that relationship in the overall classification process. For example, a strong connection between neurons detecting features “show me” and “how much” may indicate their combined influence on predicting a particular category “account inquiry” for intent.

This process continues until the final output layer generates scores for each possible category, sub-category, and/or other class. The final output layer of the network represents the predicted category for the input text. Each neuron in this layer represents a specific category, and its activation level reflects the network's confidence in that category being the correct one. Connections between the last hidden layer and the output layer may determine how the network combines the extracted features and their relationships to form a final prediction. The weights of these connections dictate the relative importance of different features and their interactions in influencing the final category score.

In some implementations, the predicted class is compared to the actual label of the transcript. The difference is referred to as loss, which indicates a level of error in the prediction compared to the correct label. The loss may then back-propagated through the network, updating the weights in each layer based on their contribution to the error. This update may be calculated using gradient descent, adjusting the weights to minimize the future loss on similar examples.

The foregoing learning process of feed-forward pass, loss minimization, and backpropagation is repeated for many training epochs, iterating over the entire labeled transcripts. As the training progresses, the weights gradually adjust, capturing the patterns and relationships within the data. The network learns to associate specific features in the text with specific labels, improving its ability to classify new, unseen text.

### The Intent Classifier, Reason Classifier, and Action Classifier

The intent classifier 136A, reason classifier 136B, and action classifier 136C may each be trained based on respective labels corresponding to intent categories and sub-categories, reason categories and sub-categories, and action categories and sub-categories.

For example, the intent classifier 136A is a neural network trained on training data to classify an input transcript into categories and sub-categories of intent. The training data may include transcripts that have each been labeled by the labeling subsystem 134 with one or more categories of intent, and one or more sub-categories of intent. For example, a given transcript in the training data may be labeled with a label indicating a category of intent and a sub-category of intent associated with the given transcript. In this manner, the intent classifier 136A may be trained to classify other transcripts into the category and sub-category. The reasons classifier 136B and the actions classifier 136C are similarly trained neural networks, but based on training data labeled with categories and sub-categories of their respective concepts. It should be noted that a single transcript may be labeled with an intent category and sub-category, a reason category and sub-category, and an actions category and sub-category (or other combinations of the foregoing).

After training the neural networks 136 in a discovery phase, during an operational phase, the computer system 110 may execute the neural networks 136 to predict concept categories and sub-categories for a given transcript. For example, a call to a call center may be recorded and transcribed for storage as content 103 in the data source 101. The transcription may be analyzed to identify concepts such as one or more intents of the call, one or more reasons for the call, one or more actions taken in connection with the call, and/or concepts identified from the transcript. The neural networks 136 may operate to categorize the transcript into corresponding categories and sub-categories based on the features and relationships in the transcript and learned features and relationships from the training data. For example, the intent classifier 136A may determine an intent category and intent sub-category for the transcript. The reason classifier 136B may determine a reason category and reason sub-category for the transcript. The action classifier 136N may determine an action category and action sub-category for the transcript.

The analysis subsystem 138 may analyze results of the neural networks 136 and aggregate them to determine trends and other actionable data. For example, the analysis subsystem 138 may identify the top-N occurring combinations of intent, intent category, intent sub-category, reason, reason category, reason sub-category, action, action category, and action sub-category. These top-N occurring combinations may serve as the focus of efforts to improve response or customer-facing systems. For example, if customers commonly call to check account balances because the website is unusable and the action taken was for the agent to walk the customer through the website, then user experience and interface usability may be addressed.

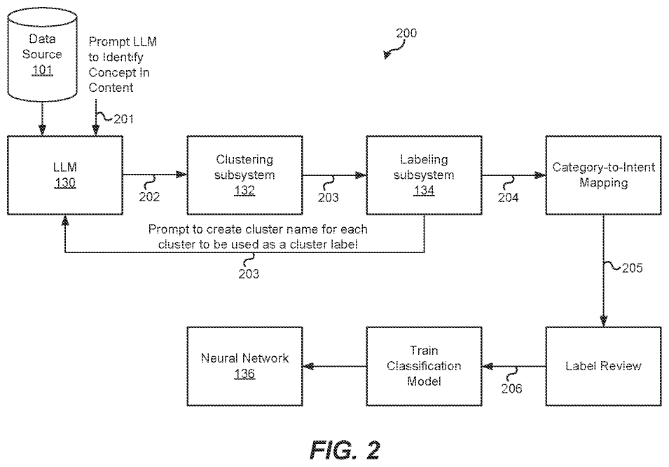

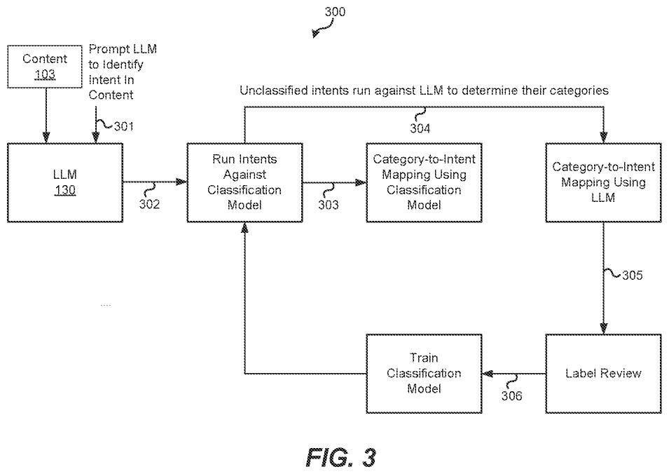

FIG. 2 illustrates a schematic flow 200 of an example discovery phase for training a neural network 136 (such as an intent classifier 136A, a reasons classifier 136B, and an actions classifier 136C) to categorize concepts such as intents, reasons, and actions identified by the LLM from transcripts, according to an implementation. The discussion of FIGS. 2 and 3 will refer to references elements described at FIG. 1.

At 201, the LLM 130 may be prompted with one or more prompts to identify, for each transcript from among a plurality of transcripts of a training dataset, one or more concepts. The concepts may include an intent of the user, an action of the agent, and a reason for call. The plurality of transcripts may be provided as input to the LLM 130 along with the one or more prompts. For purposes of illustration, a prompt to identify a caller's intent from a call transcript will be described. It should be noted that other prompts may be provided to identify a caller's reason for the call, an action taken in response to intent or reason, and/or other concepts.

The LLM 130 may be provided with the transcript such as from the data source 101. The LLM 130 may generate and provide an LLM output 131, an example of which is illustrated in Table 1, that includes the intent, reason, and action identified from the transcript.

At 202, the concepts such as intents, actions, and reasons are clustered together based on their similarity to one another other. Such clustering may be performed by the clustering subsystem 132. At 203, each of the clusters are given a label by sending the cluster list to the LLM 130. This becomes a label for the sub-category. At 204, each of the sub-categories are again grouped together for those that are similar by creating a cluster and then the clusters are given a label for as categories. Each cluster may be assigned with a cluster identifier so that even if the labels are changed, the identities of the underlying clusters are maintained so that the clusters and are still identifiable.

At 205, the category and sub-category labels are reviewed for appropriateness to the groups. This may be a human-in-the-loop process in which domain experts may review the labels to ensure they are appropriate given the concept being modeled. If the category or sub-category labels are changed, then the cluster identifier may still be used to identify the underlying data for the cluster.

At 206, the labels may be used to train the neural networks 136. Such training is described at FIG. 1 in the discussion of the neural networks 136. For example, the intent classifier 136A, the reason classifier 136B, and the action classifier 136C are trained and built to respectively categorize intents, reasons and actions into its appropriate categories, sub-categories, and/or other groups of concepts.

Once the neural networks 136 are trained during the discovery phase, the neural networks 136 may be used in an operational phase to categorize new transcripts or to re-categorize already categorized transcripts based on updated training. To illustrate, reference will be made to FIG. 3, illustrates a schematic flow 300 of an example operational phase of a neural network that categorizes concepts such as intents, reasons, or actions identified by the LLM 130 from a transcript, according to an implementation.

At 301, the LLM 130 may be provided with one or more prompts to identify one or more concepts from a transcript. The concepts may include an intent of the user, an action of the agent and a reason for the call, and/or other concepts. The LLM 130 is provided with the transcript, and generates an LLM output 131 for the transcript. The LLM output 131 may include the intent, action reason, and/or other concepts identified from the transcript.

At 302, the intents, actions and reasons are classified to their appropriate categories using the respective neural network 136. For example, the intent classifier 136A, the reason classifier 136B, and the action classifier 136C may respectively categorize the transcript into an intent, a reason and action into its appropriate categories, sub-categories, and/or other groups of concepts.

At 303, existing mappings are classified by neural networks 136 as well as new mappings that the models are able to classify.

At 304, there may be mappings that the models will not be able to classify with high probability above a threshold probability value, which may be initially predefined and/or configured as appropriate. Put another way, some mappings may have a probability of being correct that is lower than the threshold probability value.

At 305, the intents, actions and reasons are fed back through the discovery process where the intents, actions and reasons are fed through the embedding and clustering process, labeling by the LLM 130, and label review. The neural networks 136 may then be re-trained with the new dataset.

At 306, the intent categories, actions, and call reasons may be mapped together. For example, the analysis subsystem 138 may identify a top N percentile of intents-to actions-to reasons mappings to discover insights on these data, driving efficiency processes and mitigating technology or other process shortcomings. These insights may include potential issues that are to be mitigated or improved.

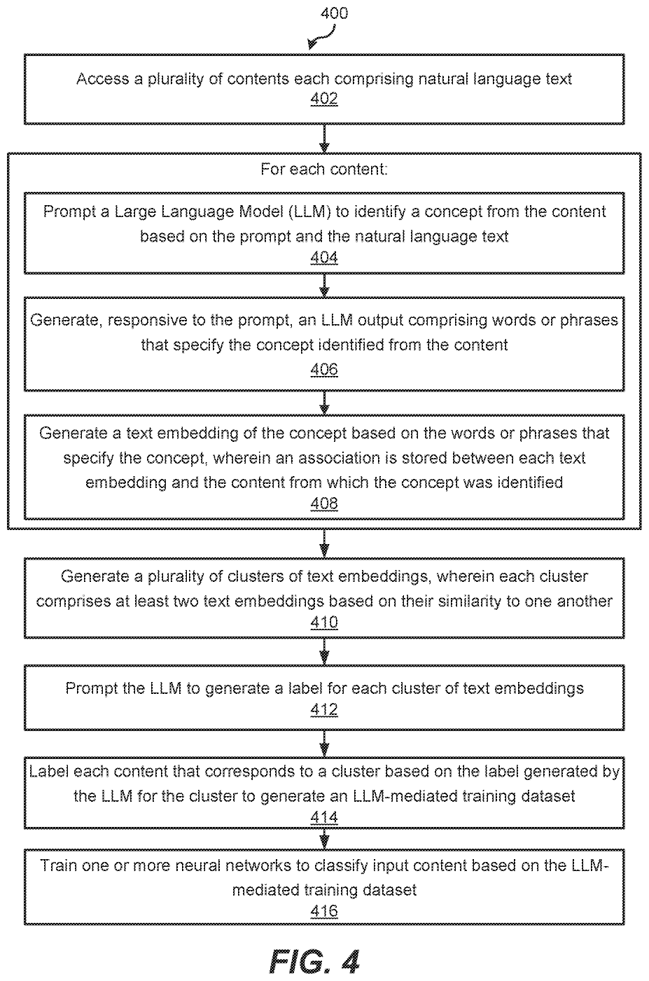

FIG. 4 illustrates a flow diagram of an example method 400 of training one or more neural networks to categorize a concept identified by an LLM from content having natural language text, according to an implementation.

At 402, the method 400 may include accessing a plurality of contents each comprising natural language text. The method 400 may include, for each content: at 404, prompting a Large Language Model (LLM) to identify a concept from the content based on the prompt and the natural language text; at 406, generating responsive to the prompt, an LLM output comprising words or phrases that specify the concept identified from the content, and, at 408, generating a text embedding of the concept based on the words or phrases that specify the concept, wherein an association is stored between each text embedding and the content from which the concept was identified.

At 410, the method 400 may include generating a plurality of clusters of text embeddings, wherein each cluster comprises at least two text embeddings based on their similarity to one another. At 412, the method 400 may include prompting the LLM to generate a label for each cluster of text embeddings. At 414, the method 400 may include labeling each content that corresponds to a cluster based on the label generated by the LLM for the cluster to generate an LLM-mediated training dataset. At 416, the method 400 may include training one or more neural networks to classify input content based on the LLM-mediated training dataset.

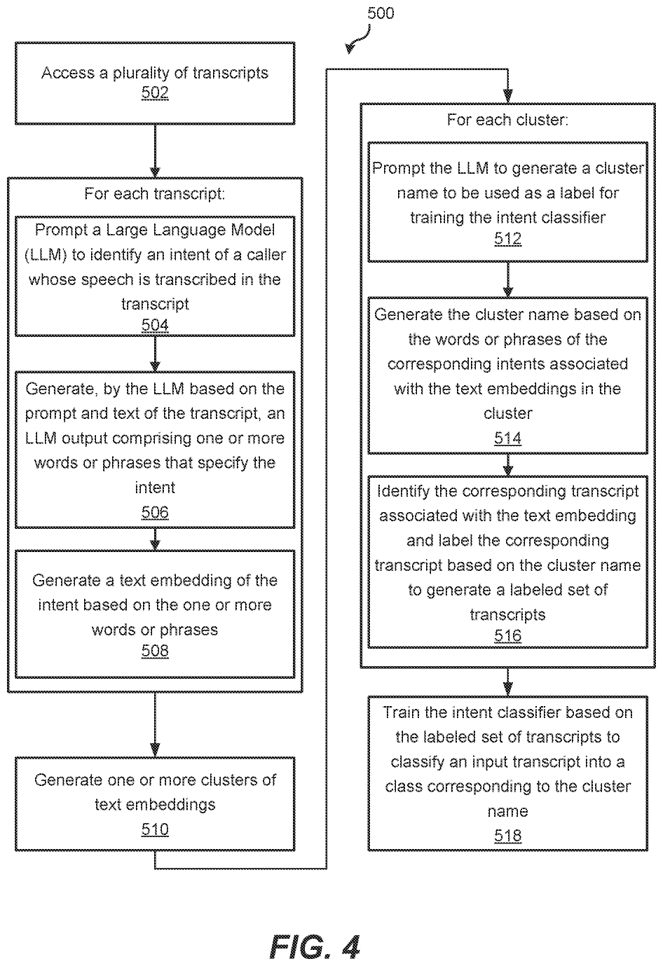

FIG. 5 illustrates a flow diagram of an example method 500 of training an intent classifier to categorize an intent identified by an LLM from a call transcript, according to an implementation.

At 502, the method 500 may include accessing a plurality of transcripts.

The method 500 may include, for each transcript from among a plurality of transcripts: at 504, prompting a Large Language Model (LLM) to identify an intent of a caller whose speech is transcribed in the transcript; at 506, generating, by the LLM based on the prompt and text of the transcript, an LLM output comprising one or more words or phrases that specify the intent; and at 508, generating a text embedding of the intent based on the one or more words or phrases.

At 510, the method 500 may include generating one or more clusters of text embeddings. Each cluster of text embeddings may include at least two text embeddings that are similar to one another beyond a threshold value and wherein each text embedding corresponds to the intent of a corresponding transcript.

The method 500 may include, for each cluster of text embeddings: at 512, prompting the LLM to generate a cluster name to be used as a label for training the intent classifier; at 514 generating the cluster name based on the words or phrases of the corresponding intents associated with the text embeddings in the cluster; and at 516, identifying the corresponding transcript associated with the text embedding and label the corresponding transcript based on the cluster name to generate a labeled set of transcripts.

At 518, the method 500 may include training the intent classifier based on the labeled set of transcripts to classify an input transcript into a class corresponding to the cluster name.

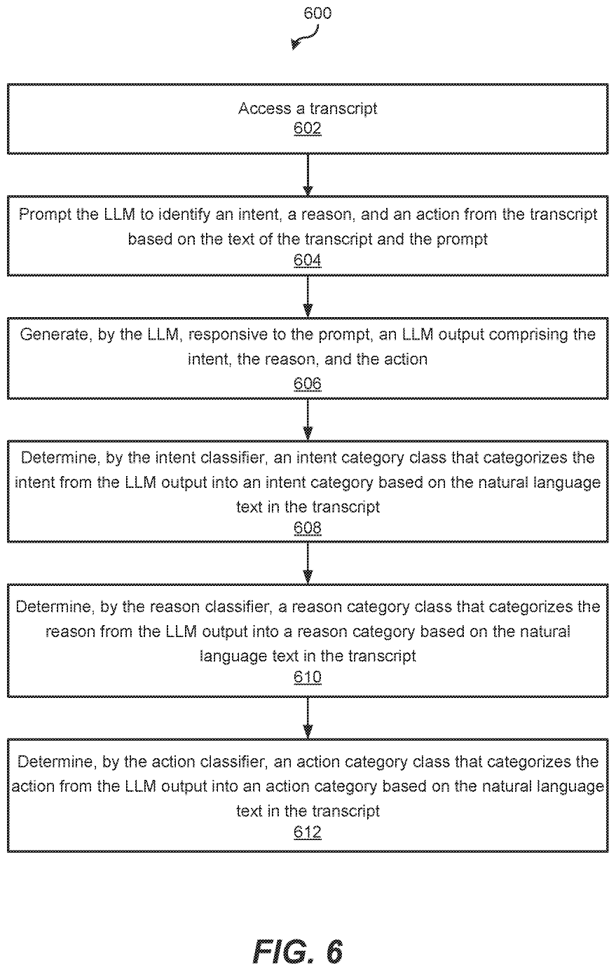

FIG. 6 illustrates a flow diagram of an example method 600 of identifying an intent, a reason, and an action in a transcript having natural language text using an LLM and classifying each intent, reason, and action based on a plurality of neural networks, according to an implementation.

At 602, the method 600 may include accessing a transcript. The transcript may be a call transcript of a call between a caller and a call center. At 604, the method 600 may include prompting an LLM (such as the LLM 130) to identify an intent, a reason, and an action from the transcript based on the text of the transcript and the prompt.

At 606, the method 600 may include generating, by the LLM, responsive to the prompt, an LLM output comprising the intent, the reason, and the action. Examples of the LLM output are described with respect to the LLM output 131.

At 608, the method 600 may include determining, by the intent classifier (such as the intent classifier 136A), an intent category class that categorizes the intent from the LLM output into an intent category based on the natural language text in the transcript.

At 610, the method 600 may include determining, by the reason classifier (such as the reason classifier 136B), a reason category class that categorizes the reason from the LLM output into a reason category based on the natural language text in the transcript.

At 612, the method 600 may include determining, by the action classifier (such as the action classifier 136C), an action category class that categorizes the action from the LLM output into an action category based on the natural language text in the transcript.

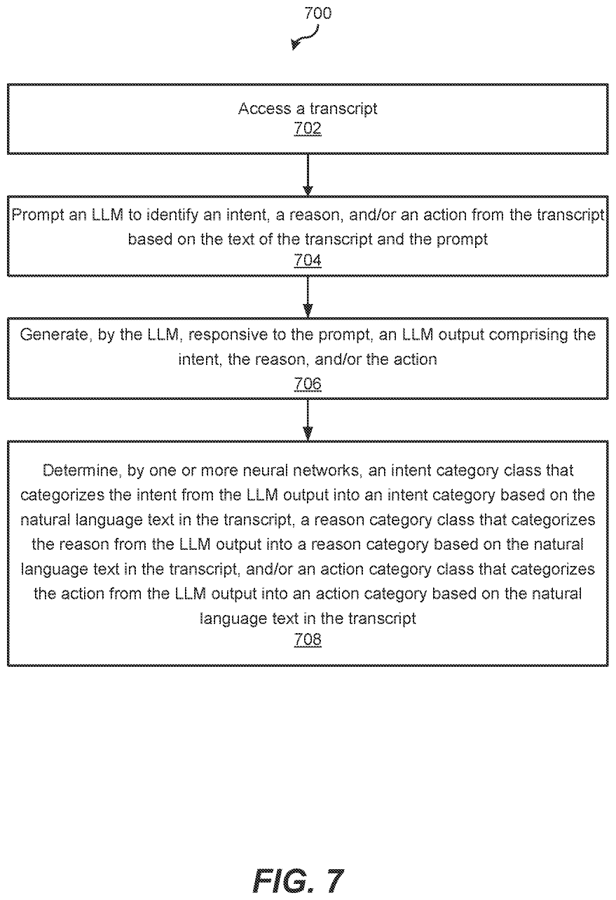

FIG. 7 illustrates a flow diagram of an example method 700 of identifying an intent, a reason, and/or an action in a transcript having natural language text using an LLM and classifying each intent, reason, and/or action based on one or more neural networks, according to an implementation. At 702, the method 700 may include accessing a transcript. The transcript may be a call transcript of a call between a caller and a call center.

At 704, the method 700 may include prompting an LLM (such as the LLM 130) to identify an intent, a reason, and/or an action from the transcript based on the text of the transcript and the prompt. For clarity, the method 700 may include prompting the LLM to identify any single one or combination of intent, reason, or action from the transcript. For example, the LLM may be prompted to identify only one or more intents from the transcript; only one or more reasons from the transaction; or only one or more actions from the transcript. In another example, the LLM may be prompted to identify one or more intents and one or more actions from the transcript. In another example, the LLM may be prompted to identify one or more intents, one or more reasons, and one or more actions from the transcript. Other combinations are contemplated as well.

At 706, the method 700 may include generating, by the LLM, responsive to the prompt, an LLM output comprising the intent, the reason, and/or the action. Examples of the LLM output are described with respect to the LLM output 131.

At 708, the method 700 may include determining, by the one or more neural networks, an intent category class that categorizes the intent from the LLM output into an intent category based on the natural language text in the transcript, a reason category class that categorizes the reason from the LLM output into a reason category based on the natural language text in the transcript, and/or an action category class that categorizes the action from the LLM output into an action category based on the natural language text in the transcript. The one or more neural networks may include an intent classifier such as the intent classifier 136A, a reason classifier such as the reason classifier 136B, and/or an action classifier such as the action classifier 136C).

Processor 112 may be configured to execute or implement 130, 132, 134, 136, and 138 by software; hardware; firmware; some combination of software, hardware, and/or firmware; and/or other mechanisms for configuring processing capabilities on processor 112. It should be appreciated that although 130, 132, 134, 136, and 138 are illustrated in FIG. 1 as being co-located in the computer system 110, one or more of the components or features 130, 132, 134, 136, and 138 may be located remotely from the other components or features. The description of the functionality provided by the different components or features 130, 132, 134, 136, and 138 described below is for illustrative purposes, and is not intended to be limiting, as any of the components or features 130, 132, 134, 136, and 138 may provide more or less functionality than is described, which is not to imply that other descriptions are limiting. For example, one or more of the components or features 130, 132, 134, 136, and 138 may be eliminated, and some or all of its functionality may be provided by others of the components or features 130, 132, 134, 136, and 138, again which is not to imply that other descriptions are limiting. As another example, processor 112 may include one or more additional components that may perform some or all of the functionality attributed below to one of the components or features 130, 132, 134, 136, and 138.

The datastores (such as 101) may be a database, which may include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The datastores may include cloud-based storage solutions. The database may store a plurality of types of data and/or files and associated data or file descriptions, administrative information, or any other data. The various datastores may store predefined and/or customized data described herein.

Each of the computer system 110 and client devices 160 may also include memory in the form of electronic storage. The electronic storage may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionalities described herein.

The computer system 110 and the one or more client devices 160 may be connected to one another via a communication network (not illustrated), such as the Internet or the Internet in combination with various other networks, like local area networks, cellular networks, or personal area networks, internal organizational networks, and/or other networks. It should be noted that the computer system 110 may transmit data, via the communication network, conveying the predictions one or more of the client devices 160. The data conveying the predictions may be a user interface generated for display at the one or more client devices 160, one or more messages transmitted to the one or more client devices 160, and/or other types of data for transmission. Although not shown, the one or more client devices 160 may each include one or more processors, such as processor 112.

The systems and processes are not limited to the specific implementations described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system features illustrated in FIGS. 1, 4 and 6.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to execute one or more neural networks, the one or more neural networks comprising an intent classifier trained to classify an intent into one or more intent categories, a reason classifier trained to classify the reason into one or more reason categories, and/or an action classifier trained to classify the action into one or more action categories, and wherein the processor is programmed to:
access a transcript;
prompt a Large Language Model (LLM) to identify an intent, a reason, and/or an action from the transcript based on the natural language text of the transcript and the prompt;
generate, by the LLM, responsive to the prompt, an LLM output comprising the intent, the reason, and/or the action; and
determine, by the one or more neural networks, an intent category class that categorizes the intent from the LLM output into an intent category based on the natural language text in the transcript, a reason category class that categorizes the reason from the LLM output into a reason category based on the natural language text in the transcript, and/or an action category class that categorizes the action from the LLM output into an action category based on the natural language text in the transcript.

2. The system of claim 1, wherein the processor is further programmed to:
identify a potential issue that is to be mitigated based on the intent category class, the reason category class, and/or the action category class.

3. The system of claim 1, wherein the LLM is prompted to identify the intent from the transcript and the one or more neural networks comprises an intent classifier that determines the intent category class, and wherein the processor is further programmed to:
determine a probability that the intent category class is correct;
determine that the probability is below a threshold probability value such that the intent category class is not able to classify the intent into a category or sub-category; and
initiate a discovery process to retrain the intent classifier to identify the category or the sub-category for the intent.

4. The system of claim 3, wherein the processor is further programmed to:
generate a text embedding based on text of the intent;
cluster, into a first cluster, the text embedding with other text embeddings of other intents identified from other transcripts in a training dataset, wherein the text embedding is clustered into the first cluster based on a similarity between the text embedding and the other text embeddings, wherein the first cluster represents a sub-category for the intent; and
train the intent classifier based on the first cluster.

5. The system of claim 4, wherein the processor is further programmed to:
prompt the LLM to generate a sub-category name for the first cluster;
label the transcripts in the first cluster with the sub-category name; and
retrain the intent classifier based on the labeled transcripts.

6. The system of claim 5, wherein to re-train the intent classifier, the processor is further programmed to:
initiate a review of the sub-category name for use as a label, wherein the intent classifier is retrained after the review of the sub-category name for use as the label.

7. A method for training neural networks, comprising:
accessing, by a processor, a plurality of contents each comprising natural language text;
for each content:
prompting, by the processor, a Large Language Model (LLM) to identify a concept from the content based on the prompt and the natural language text;
generating, by the processor executing the LLM, responsive to the prompt, an LLM output comprising words or phrases that specify the concept identified from the content; and
generating, by the processor, a text embedding of the concept based on the words or phrases that specify the concept, wherein an association is stored between each text embedding and the content from which the concept was identified;
generating, by the processor, a plurality of clusters of text embeddings, wherein each cluster comprises at least two text embeddings based on their similarity to one another;
prompting, by the processor, the LLM to generate a label for each cluster of text embeddings;
labeling, by the processor, each content that corresponds to a cluster based on the label generated by the LLM for the cluster to generate an LLM-mediated training dataset; and
training, by the processor, one or more neural networks to classify input content based on the LLM-mediated training dataset.

8. The method of claim 7, wherein the content comprises a transcript of multi-media, a communication, a document, or an article.

9. The method of claim 7, wherein the content comprises a transcript of a call, the concept comprises at least an intent of a caller for making the call, and the one or more neural networks comprise an intent classifier trained to categorize the intent.

10. The method of claim 9, wherein the concept further comprises a reason for the call, and the one or more neural networks comprise a reason classifier trained to categorize the reason, the method further comprising:
determining, by the reason classifier, a category for the reason.

11. The method of claim 9, wherein the concept further comprises an action taken in response to the call, and the one or more neural networks comprise an action classifier trained to categorize the action, the method further comprising:
determining, by the action classifier, a category for the action.

12. The method of claim 7, wherein the label corresponds to a sub-category name, the method further comprising:
clustering at least some the plurality of clusters into one or more second clusters, wherein each second cluster of the one or more second clusters comprises at least two clusters of text embeddings that are similar to one another beyond a second threshold value and wherein each second cluster represents a category for the sub-categories in the one or more second clusters;
for each second cluster:
prompt the LLM to generate a category name to be used as a second label for training the one or more neural networks;
generate the category name based on the words or phrases of the corresponding sub-category names; and
identify the corresponding content associated with the second cluster name and label each of the corresponding content based on the category name to generate the LLM-mediated training dataset with both the category name and the label.

13. The method of claim 7, further comprising:
during an operational phase, determining a probability that a classification for the concept is correct;
determining that the probability is below a threshold probability value; and
initiating a discovery process to retrain the one or more neural networks.

14. The method of claim 13, further comprising:
generating a text embedding based on text of the concept; and
clustering, into a first cluster, the text embedding with other text embeddings of other concepts identified from other transcripts in a training dataset, wherein the text embedding is clustered into the first cluster based on a similarity between the text embedding and the other text embeddings, wherein the first cluster is used to determine a new category for the concept.

15. The method of claim 14, further comprising:
prompting the LLM to generate a sub-category name for the first cluster;
labeling the transcripts in the first cluster with the sub-category name; and
re-training the one or more neural networks based on the labeled transcripts.

16. The method of claim 15, wherein re-training the one or more neural networks comprises:
initiating a review of the sub-category name for use as a label, wherein the one or more neural networks are retrained after the review of the sub-category name for use as the label.

17. A non-transitory computer readable medium storing instructions for training an intent classifier comprising a neural network to categorize an intent of a caller from a transcript of a call, the instructions, when executed by a processor, programs the processor to:
access a plurality of transcripts;
for each transcript from among a plurality of transcripts:
prompt a Large Language Model (LLM) to identify an intent of a caller whose speech is transcribed in the transcript;
generate, by the LLM based on the prompt and text of the transcript, an LLM output comprising one or more words or phrases that specify the intent;
generate a text embedding of the intent based on the one or more words or phrases;
generate one or more clusters of text embeddings, wherein each cluster of text embeddings comprises at least two text embeddings that are similar to one another beyond a threshold value and wherein each text embedding corresponds to the intent of a corresponding transcript;
for each cluster of text embeddings:
prompt the LLM to generate a cluster name to be used as a label for training the intent classifier;
generate the cluster name based on the words or phrases of the corresponding intents associated with the text embeddings in the cluster;
identify the corresponding transcript associated with the text embedding and label the corresponding transcript based on the cluster name to generate a labeled set of transcripts; and
train the intent classifier based on the labeled set of transcripts to classify an input transcript into a class corresponding to the cluster name.

18. The non-transitory computer readable medium of claim 17, wherein the cluster name corresponds to a sub-category name, the one or more clusters of text embeddings comprises a plurality of clusters of text embeddings, and wherein the instructions, when executed by the processor, further programs the processor to:
cluster at least some the plurality of clusters into one or more second clusters, wherein each second cluster of the one or more second clusters comprises at least two clusters of text embeddings that are similar to one another beyond a second threshold value and wherein each second cluster represents a category for a corresponding intent;
for each second cluster:
prompt the LLM to generate a category name to be used as a second label for training the intent classifier;
generate the category name based on the words or phrases of the corresponding sub-category names; and
identify the corresponding transcripts associated with the second cluster name and label each of the corresponding transcripts based on the category name to generate the labeled set of transcripts with both the category name and the sub-category name,
wherein the intent classifier is trained based on the labeled set of transcripts with both the category name and the sub-category name to classify an input transcript in a category class and a sub-category class.

19. The non-transitory computer readable medium of claim 17, wherein the instructions, when executed, further programs the processor to:
for each transcript from among the plurality of transcripts:
prompt the LLM to identify a reason for the call and an action, responsive to the call, that was taken, wherein the LLM output further comprises one or more second words or phrases that specify the reason and one or more third words or phrases that specify the action;
generate a second text embedding of the reason based on the one or more second words or phrases and a third text embedding of the action based on the one or more third words or phrases;
train a reason classifier based on the second text embedding; and
train an action classifier based on the third text embedding.

20. The non-transitory computer readable medium of claim 17, wherein the instructions, when executed, further programs the processor to:
initiate a review of the cluster name for use as a label, wherein the intent classifier is trained after the review of the cluster name for use as the label.
